(19) United States
(12) Patent Application Publication
(10) Pub. No.: US 2008/0286449 A1
(43) Pub. Date: Nov. 20, 2008

(54) Template for Nano Imprint Lithography Process and Method of Manufacturing Semiconductor Device Using the Same

(75) Inventor: Sa Ro Han Park, Seoul (KR)

Correspondence Address: MARSHALL, GERSTEIN & BORUN LLP, 233 S. WACKER DRIVE, SUITE 6300, SEARS TOWER, CHICAGO, IL, 60606, US

(73) Assignee: HYNIX SEMICONDUCTOR INC., Icheon-Si (KR)

(21) Appl. No.: 11/866,223

(22) Filed: Oct. 2, 2007

(30) Foreign Application Priority Data
May 14, 2007 (KR) 10-2007-0046692

(51) Int. Cl. B05D 3/12; G03C 5/00

(52) U.S. Cl. 427/123; 430/323

(57) ABSTRACT

A method of manufacturing a template for nano imprint lithography process may include: forming a chrome layer, an intermediate film, and a photoresist film sequentially over a substrate. The method may further include forming a photoresist film pattern; forming an intermediate film pattern with the photoresist film pattern as an etching mask; and forming a spacer at a sidewall of the intermediate film pattern. The intermediate film pattern may be removed using an etching selectivity between the intermediate film pattern and the spacer. Finally, the chrome layer and the substrate may be etched using the spacer as an etching mask to form the template.

### CROSS-REFERENCES TO RELATED APPLICATIONS

The present application claims priority to Korean patent application number 10-2007-0046692, filed on May 14, 2007, which is incorporated by reference in its entirety, is claimed.

### SUMMARY OF THE INVENTION

The present invention generally relates to a template for nano imprint lithography process and a method of manufacturing a semiconductor device using the same. More specifically, the present invention relates to a template for nano imprint lithography under development into the next generation lithography using a spacer patterning technology, which has been applied in a method of manufacturing a semiconductor device that may include the step of forming a fine pattern.

Various embodiments of the present invention are directed at providing a method of manufacturing a template for nano imprint lithography process. The template, which serves as a mask of magnification by one time, has an improved resolution using a spacer patterning technology, thereby facilitating improvement of high-integrated semiconductor devices.

Various embodiments of the present invention are directed at providing a method of manufacturing a semiconductor device, which may include forming a fine pattern using the template for nano imprint lithography process.

According to an embodiment of the present invention, a method of manufacturing a template for nano imprint lithography process may include: forming a chrome layer, an intermediate film, and a photoresist film sequentially over a substrate; performing a photo-etching process on the photoresist film with an exposure mask to form a photoresist film pattern; forming an intermediate film pattern with the photoresist film pattern as an etching mask; forming a spacer at a sidewall of the intermediate film pattern; removing the intermediate film pattern using an etching selectivity between the intermediate film pattern and the spacer; and etching the chrome layer and the substrate with the spacer as an etching mask to form the template.

According to an embodiment of the present invention, a template for nano imprint lithography process may be manufactured by the method.

According to an embodiment of the present invention, a method of manufacturing a semiconductor device may include forming a fine pattern by performing a nano imprint lithography process using the template for nano imprint lithography process.

According to an embodiment of the present invention, the method of manufacturing a semiconductor device may include: forming an underlying layer over a semiconductor substrate having a given lower structure; and performing a nano imprint lithography process on the underlying layer using the template for nano imprint lithography process. The underlying layer may include an interlayer insulating film or a metal film.

According to an embodiment of the present invention, the method of manufacturing a semiconductor device may include forming a recess pattern in a given region of a semiconductor substrate using a template manufactured by the method.

### BRIEF DESCRIPTION OF THE DRAWINGS

FIGS. 1a through 1d are cross-sectional diagrams illustrating a method of manufacturing a fine pattern of semiconductor device using a conventional nano imprint lithography process.

FIGS. 2a through 2c are cross-sectional diagrams illustrating a conventional method of manufacturing a template for nano imprint lithography process.

FIGS. 3a through 3f are cross-sectional diagrams illustrating a method of manufacturing a template for nano imprint lithography process according to an embodiment of the present invention.

### DETAILED DESCRIPTION OF THE SPECIFIC EMBODIMENT

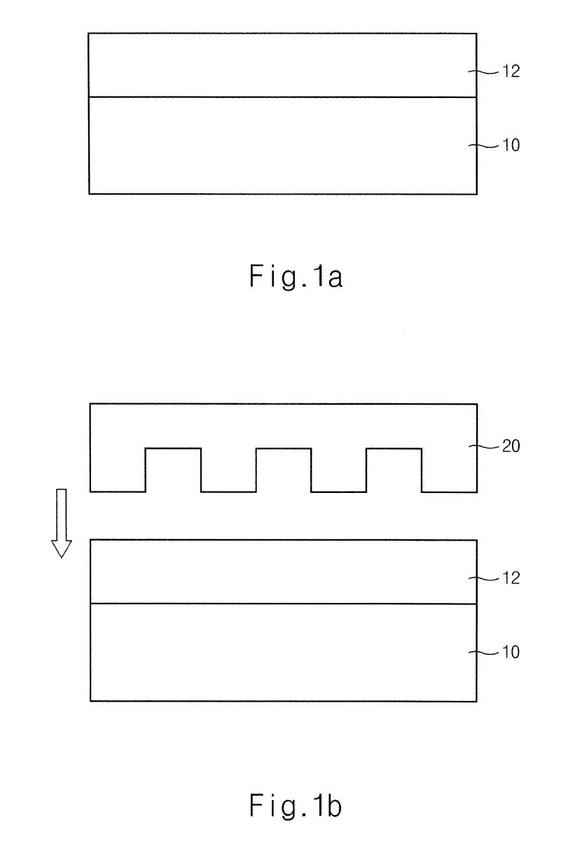

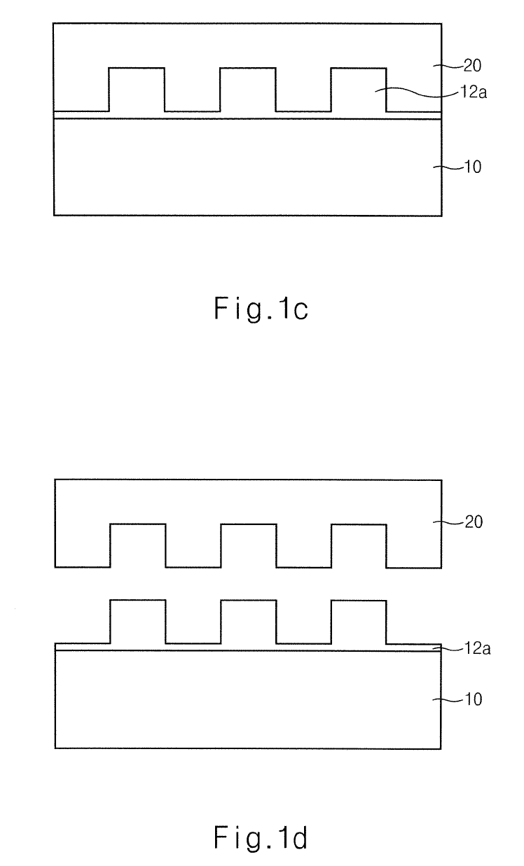

FIGS. 1a through 1d are cross-sectional diagrams illustrating a method of manufacturing a fine pattern of a semiconductor device using a conventional nano imprint lithography process.

Referring to FIG. 1a, a polymer for nano imprint is coated over a semiconductor substrate 10 to form a polymer layer 12.

Referring to FIGS. 1b through 1d, a polymer layer pattern 12a is formed in the polymer layer 12 over the semiconductor substrate 10 using a template 20 having a desired pattern. The polymer layer pattern 12a is hardened for a given time, and the template 20 is removed from the polymer layer pattern 12a.

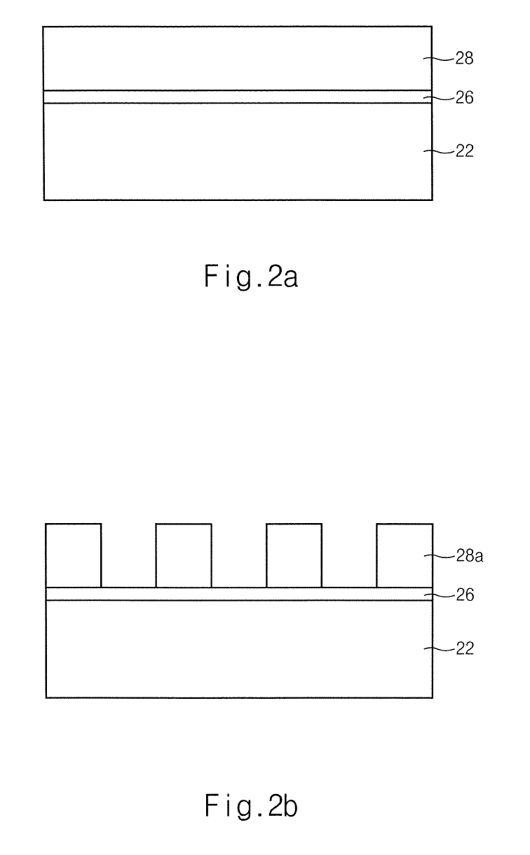

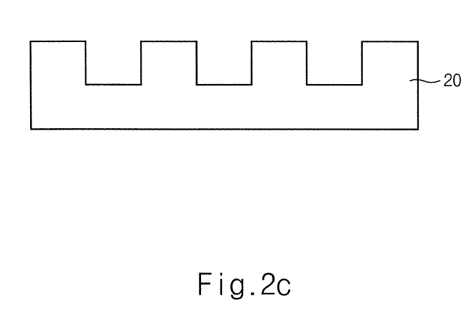

FIGS. 2a through 2c are cross-sectional diagrams illustrating a conventional method of manufacturing the template 20 for nano imprint lithography process.

Referring to FIG. 2a, a chrome layer 24 is formed over a quartz substrate 22, and then photoresist film 28 is formed over the chrome layer 24.

Referring to FIG. 2b, the photoresist film 28 is selectively etched by a photo-etching process with an exposure mask (not shown) to form a photoresist film pattern 28a having a ratio of line pattern to space pattern of 1 to 1.

Referring to FIG. 2c, the chrome layer 24 and the quartz substrate 22 are etched with the photoresist film pattern 28a as an etching mask to obtain the template 20 having a ratio of line pattern to space pattern of 1 to 1.

However, although the nano imprint lithography process facilitates formation of patterns of less than 30 nm, a template that serves as a mask has magnification by one time, and is required to have the same size of a pattern which is actually obtained in the template manufacturing.

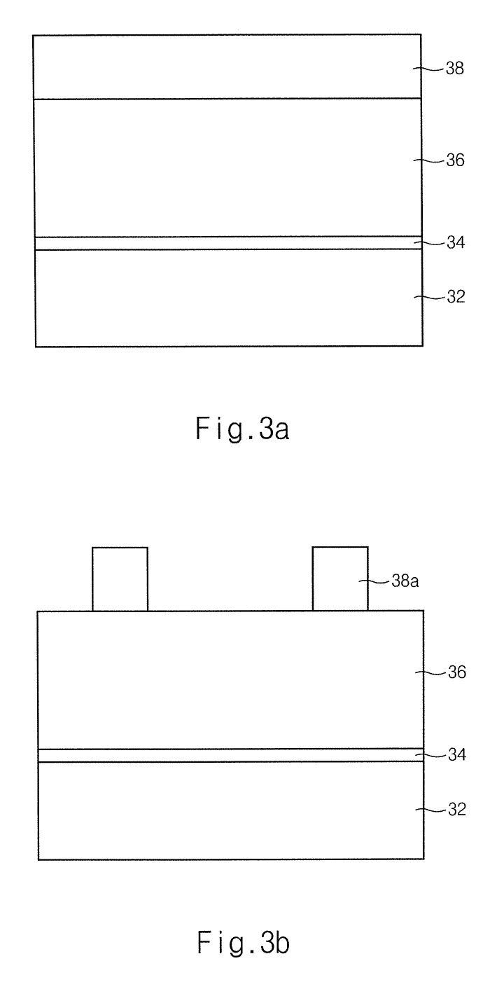

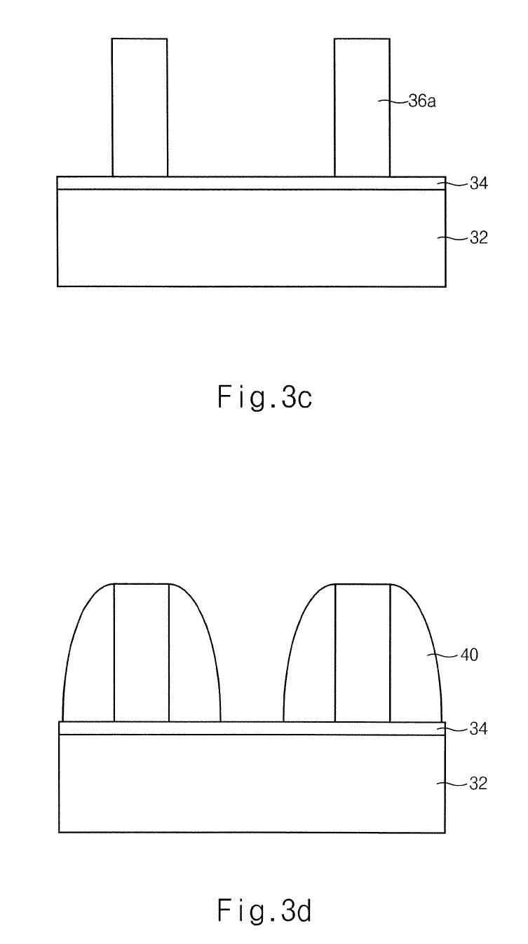

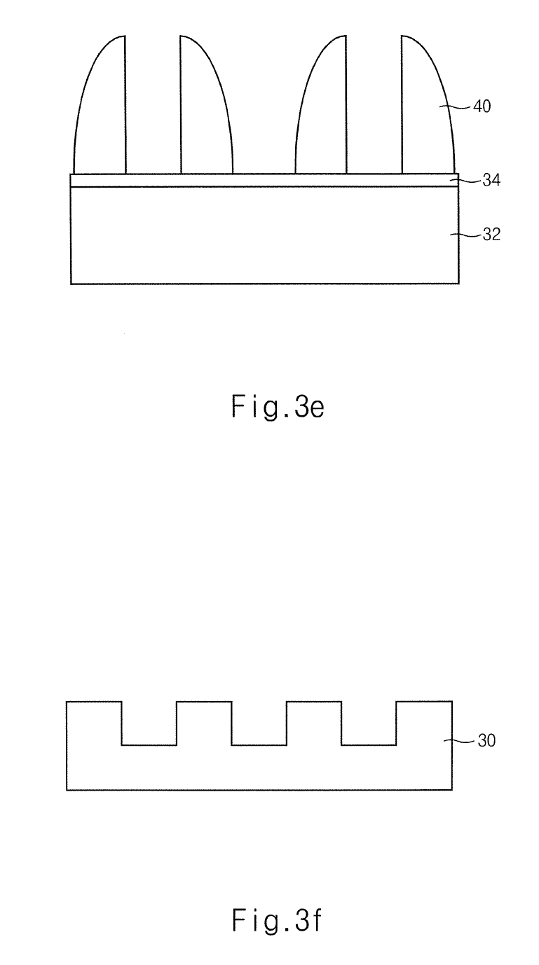

FIGS. 3a through 3f are cross-sectional diagrams illustrating a method for manufacturing a template for nano imprint lithography process according to an embodiment of the present invention.

Referring to FIG. 3a, a chrome layer 34 is formed over a substrate 32, formed, for example, of quartz. An intermediate film 36 is formed over the chrome layer 34. A photoresist film 38 is formed over the intermediate film 36.

The intermediate film 36 may have a thickness of about 100 to 10000 Å. The intermediate film may be formed, for example, of plasma enhanced tetraethyl orthosilicate (TEOS) oxide film.

Referring to FIG. 3b, the photoresist film 38 is selectively etched by a photo-etching process with an exposure mask (not shown), thereby obtaining a photoresist film pattern 38a having a ratio of line pattern to space pattern of about 1 to 3.

Referring to FIG. 3c, the bottom of the intermediate film 36 is etched with the photoresist film pattern 38a as an etching mask, thereby obtaining an intermediate film pattern 36a having a ratio of line pattern to space pattern of about 1 to 3.

Referring to FIG. 3d, a film, for example a nitride film or an oxide film, is deposited over the resulting structure including the intermediate film pattern 36a. A blanket-etching process is performed to form a spacer 40 at a sidewall of the intermediate film pattern 36a.

Referring to FIG. 3e, the intermediate film pattern 36a is removed using an etching selectivity between the intermediate film pattern 36a and the spacer 40.

The etching selectivity of the intermediate film pattern may be larger than that of the spacer by more than about 5 times, preferably about 5 to about 20 times. The intermediate film pattern 36a may be removed, for example, by a dip-out process with a hydrofluoric acid (HF) solution.

Referring to FIG. 3f, the chrome layer 34 and the substrate 36 are etched with the spacer 40 as an etching mask to form a template pattern, thereby obtaining a template for nano imprint lithography process 30 having a ratio of line pattern to space pattern of 1 to 1.

When a pitch between the photoresist film pattern 38a is A, a pitch between pattern formed in the template 30 is A/2.

In other words, a resolution of the template that serves as a mask having magnification by one time can be improved by two times.

The method of manufacturing a template for nano imprint lithography process can be performed in patterns of less than about 100 nm.

After the spacer 40 is formed, an additional material may be deposited and the spacer 40 may be removed. As a result, a negative spacer patterning technology can be used.

A mask process may be further performed in the manufacturing of templates for nano imprint lithography process, thereby obtaining a peripheral circuit region or a two-dimensional pattern.

A nano imprint lithography process is performed using the template for nano imprint lithography process manufactured by the method, thereby obtaining a fine pattern of a semiconductor device.

That is, the size of the pattern can be reduced when an interlayer insulating film pattern or a metal pattern is formed by using the template for nano imprint lithography process manufactured by the method.

The method of manufacturing a semiconductor device may include forming an underlying layer over a semiconductor substrate having a given lower structure, and performing a nano imprint lithography process on the underlying layer, such as the interlayer insulating film or the metal film, using the template for nano imprint lithography, thereby obtaining an underlying layer pattern having a reduced size.

The method of manufacturing a semiconductor device may further include forming a recess pattern having a reduced pattern size in a given region of a semiconductor substrate.

As described above, according to an embodiment of the present invention, a template for nano imprint lithography process that serves as a mask having magnification by one time improves a resolution, thereby facilitating improvement of high-integrated semiconductor devices.

The above embodiments of the present invention are illustrative and not limitative. Various alternatives and equivalents are possible. The invention is not limited by the lithography steps described herein. Nor is the invention limited to any specific type of semiconductor device. For example, the present invention may be implemented in a dynamic random access memory (DRAM) device or non volatile memory device. Other additions, subtractions, or modifications are obvious in view of the present disclosure and are intended to fall within the scope of the appended claims.

What is claimed is:

1. A method of manufacturing a template for nano imprint lithography process, the method comprising:
forming a chrome layer, an intermediate film and a photoresist film sequentially over a substrate;
forming a photoresist film pattern;
forming an intermediate film pattern with the photoresist film pattern as an etching mask;
forming a spacer at a sidewall of the intermediate film pattern;
removing the intermediate film pattern using an etching selectivity between the intermediate film pattern and the spacer; and
etching the chrome layer and the substrate using the spacer as an etching mask to form the template.

2. The method according to claim 1, wherein the photoresist film pattern has a ratio of line pattern to space pattern of 1 to 3.

3. The method according to claim 1, wherein the intermediate film comprises a plasma enhanced tetraethyl orthosilicate (TEOS) oxide film.

4. The method according to claim 1, wherein the intermediate film has a thickness ranging from 100 to 10000 Å.

5. The method according to claim 1, wherein the etching selectivity of the intermediate film pattern is larger than that of the spacer by 5 to 20 times.

6. The method according to claim 1, wherein the intermediate film pattern is removed using a dip-out process with a HF solution.

7. The method according to claim 1, wherein a pitch between the photoresist film pattern is A, and a pitch between the template is A/2.

8. A template for nano imprint lithography process manufactured by the method of claim 1.

9. A method of manufacturing a semiconductor device, the method comprising performing a nano imprint lithography process using the template for nano imprint lithography process manufactured by the method of claim 1.

10. The method according to claim 9, wherein the method further comprises:
forming an underlying layer over a semiconductor substrate having a given lower structure; and
performing a nano imprint lithography process on the underlying layer using the template for nano imprint lithography process manufactured by the method of claim 1.

11. The method according to claim 10, wherein the underlying layer includes an interlayer insulating film or a metal film.

12. The method according to claim 9, wherein the method further comprises forming a recess pattern in a given region of a semiconductor substrate using the template for nano imprint lithography process manufactured by the method of claim 1.
